(19) United States
(12) Patent Application Publication
(10) Pub. No.: US 2009/0203318 A1
(43) Pub. Date: Aug. 13, 2009

(54) HEADSET

(76) Inventor: Ido de Haan, Assen (NL)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(21) Appl. No.: 12/028,868

(22) Filed: Feb. 11, 2008

(51) Int. Cl. H04B 7/00; H04R 25/00; H04M 1/00

(52) U.S. Cl. 455/41.3; 381/381; 381/375; 455/569.1

(57) ABSTRACT

The invention relates to a headset comprising a housing with an earphone and at least one user interface input or output function, said headset also comprising a fastening element arranged for positioning the headset close to a person's ear during use. According to the invention, said headset furthermore comprises an accelerometer arranged for detecting the orientation in at least one dimension of said housing, said accelerometer being associated with a headset control unit which is arranged for configuring a function of said user interface input or output function depending on said orientation of the housing.

### FIELD OF THE INVENTION

The present invention relates to a headset comprising a housing with an earphone and at least one user interface input or output function, said headset also comprising a fastening element arranged for positioning the headset close to a person's ear during use.

### BACKGROUND

Today, there exist many types of electronic devices such as mobile telephones, media players, palmtop computers etc. Such devices are often associated with a headset, i.e. a separate unit being arranged to be mounted on or close to a user's left or right ear. The headset normally comprises an earphone and a microphone for the output and input, respectively, of audio signals. Such audio signals are transmitted between the headset and the associated electronic device. Today, such a configuration is commonly used in the field of mobile telephones, in order to allow so-called “hands-free” operation of the mobile telephone.

In the case of mobile telephones, the headset is arranged so that the earphone is positioned close to a user's ear and so that the microphone is positioned close to the user's mouth. In order to position the headset in such a way, it normally comprises a so-called ear loop device, i.e. a generally annular element used in order to mount the headset on either the left or right ear of the user.

According to known technology, a headset is normally provided with certain user interface (“man machine interface”) functions, for example in the form of input controls for receiving user commands or making selections related to the operation of the device. For example, a headset can be provided with control buttons for increasing or decreasing the volume of the audio signal being fed to the earphone. Other examples of such user interface controls are buttons for selecting the “next music track” or the “previous music track”. Such controls are useful for example in media players or in mobile telephones having a music player function.

Certain types of headsets comprises a unit in the form of a housing which carries an earphone and a microphone. The housing suitably has an elongated shape so that the earphone can be positioned close to the user's ear and so that the microphone can be positioned close to the user's mouth. Depending on whether the headset is to be used on the user's left or right ear, the housing will be arranged in two different orientations. More precisely, the elongated housing will be arranged “upside down” on the left ear as compared with its configuration on the right ear. In such case, it might be that the user interface controls will be positioned in a different order (as perceived by the user) when the headset is used on the left ear as compared with the situation in which it is used on the right ear.

If the user interface controls are positioned in different positions, i.e. from a user s perspective, depending on whether the headset is used on the left or right ear, such a situation can be perceived as annoying and confusing for the user. This is obviously a disadvantage, in particular in the field of electronic devices such as mobile telephones, where there is a demand for a high degree of user-friendliness and a need for a logical user interface.

### SUMMARY OF THE INVENTION

With the above and following description in mind, an aspect of certain embodiments of the present invention is to provide a headset, suitably for handheld, portable devices such as for example mobile telephones, in which the above-mentioned drawbacks can be overcome, and which can be used for providing a user-friendly and logical user interface.

By means of the invention, there is provided a headset of the kind mentioned initially which furthermore comprises an accelerometer arranged for detecting the orientation in at least one dimension of said housing, said accelerometer being associated with a headset control unit which is arranged for configuring a function of said user interface input or output function depending on said orientation of the housing.

The invention presents an advantage in that a user interface function can be adapted to the actual orientation, for example in the vertical direction, of the headset. For example, certain buttons or keys which are used as input controls on the headset can be configured in accordance with the orientation of the headset. This leads to a more flexible, user-friendly and useful operation of the headset.

According to an embodiment of the invention, the user interface input or output function may comprise a set of buttons for controlling the volume of said earphone.

Suitably, the housing also supports a microphone.

According to an embodiment of the invention, the housing may have a generally elongated shape so as to allow positioning of the earphone close to a user's ear and to allow positioning of the microphone close to a user's mouth.

Furthermore, the headset is suitably associated with a communication device. This communication device is preferably constituted by a mobile telephone.

According to a further embodiment, the headset may be arranged for communicating with a communication device via a wireless connection. The wireless connection is suitably arranged in accordance with the Bluetooth wireless protocol. According to a further embodiment, the invention may be arranged for communicating with the communication device via a wired connection.

Also, according to an embodiment, the headset according to the invention may comprise a fastening element which is constituted by an essentially annular ear loop device for mounting said headset on a user's left or right ear.

Furthermore, it should be emphasised that the term comprising or comprises, when used in this description and in the appended claims to indicate included features, elements or steps, is in no way to be interpreted as excluding the presence of other features elements or steps than those expressly stated.

### BRIEF DESCRIPTION OF THE DRAWINGS

The invention will now be described in more detail with reference to certain embodiments and to the attached drawings, in which:

FIG. 1 shows a schematic view of a headset designed according to the principles of the invention, said headset communicating with a mobile telephone;

FIG. 2a shows a perspective view of the headset according to the invention, as regarded from a first angle;

FIG. 2b shows a further perspective view of the headset according to the invention, as regarded from a second angle;

FIG. 3a shows a side view of the headset, in a position in which it is worn on a user's right ear;

FIG. 3b shows a further side view of the headset, in a further position in which it is worn on a user's left ear; and

FIG. 4 is a schematical block diagram of a control unit forming part of the headset according to the invention.

### DETAILED DESCRIPTION OF A PREFERRED EMBODIMENT

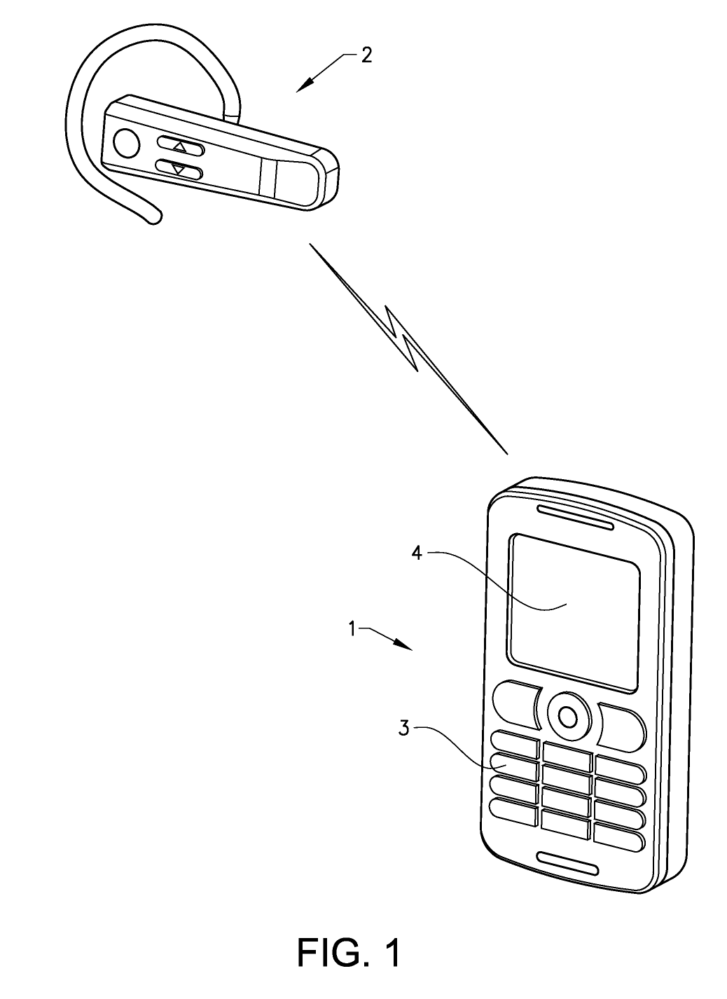

With reference to FIG. 1, there is shown a schematic view of a handheld, portable mobile telephone 1 being associated with and communicating with a headset 2. It should be mentioned that the invention is not limited to be used in mobile telephones only. The invention can equally well be used, for example, in media players (for example so-called mp3 players), palmtop computers, smartphones, electronic game units, handheld DVD players, pagers and similar devices.

As will be described below, the invention can generally be applied in all types of headsets being associated with any device wherein the device or headset, or both, are provided with user interface input or output control functions, for example in the form of volume buttons.

In a conventional manner, the mobile telephone 1 is provided with a key pad 3 and a display 4. The mobile telephone 1 is also arranged for communicating with the headset 2. As shown schematically in FIG. 1, the communication between the mobile telephone 1 and the headset 2 may be wireless, by means of a wireless communications protocol such as for example the Bluetooth wireless protocol. The manner in which different units communicate via the Bluetooth protocol is previously known as such, and for this reason it will not be described in detail here.

It should furthermore be noted that the principles of the present invention can also be implemented in headsets being connected to a further device via a wired communication line, i.e. the invention is not limited to wireless communication only.

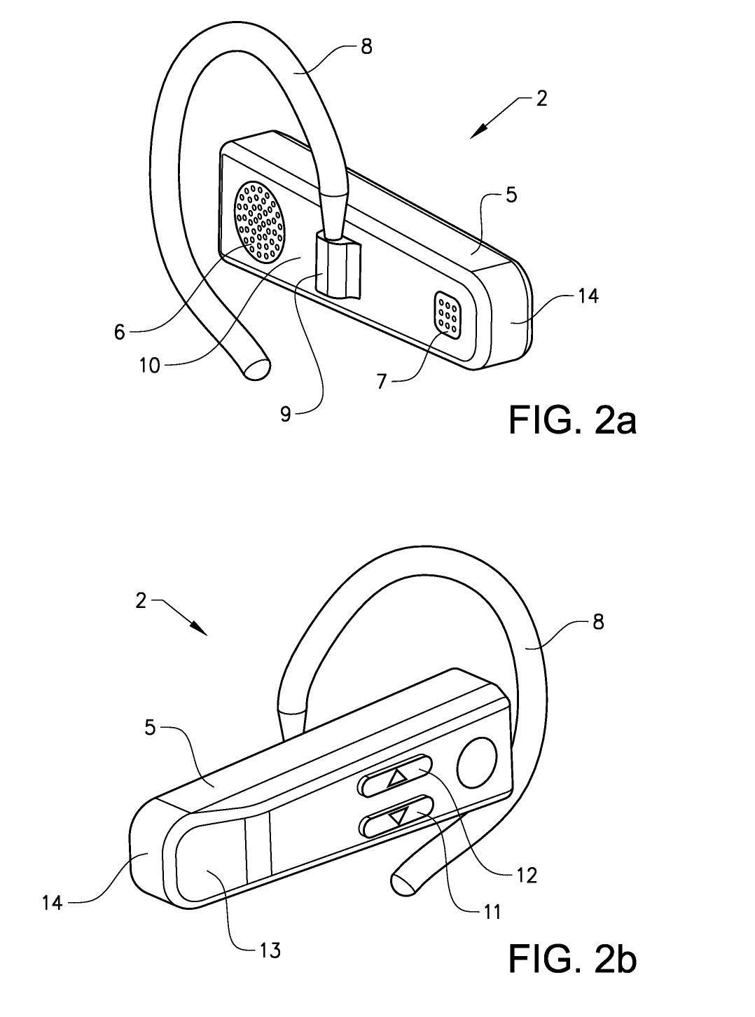

FIGS. 2a and 2b show the headset according to an embodiment as regarded from two different perspective views. As shown in FIG. 2a, it is apparent that the headset 2 comprises a housing 5 which is suitably elongated, i.e. having a design with notably more length than width. Furthermore, the housing 5 carries an earphone 6 and a microphone 7. The headset 2 also comprises a fastening element in the form of an ear loop device 8 which is used for fastening the entire headset 2 on either one of a person's left or right ear (not shown). The ear loop device 8 is furthermore arranged to be releasably mounted in a fastening component 9 in the housing 5. The earphone 6, the microphone 7 and the fastening component 9 are arranged on an inner surface 10 of the headset 2, i.e. a surface facing the ear and cheek of a person when wearing the headset 2.

As shown in FIG. 2b, which shows the headset 2 according to FIG. 2a but seen from a different angle, the housing 5 also carries a first button 11 and a second button 12. These buttons 11, 12 are arranged on, or in close connection, to an outer surface 13 of the headset 2, i.e. a surface facing outward from the ear and head of a person who is wearing the headset 2. The headset 2 also presents a front surface 14, i.e. a surface pointing in a forwards direction as regarded by a user during use.

The buttons 11, 12 are examples of controls forming part of a user interface, or a man-machine interface (MMI). According to the embodiment shown, the first button 11 can be used for decreasing the volume in the earphone 6, and the second button 12 can be used for increasing the volume in the earphone 6. The invention is not limited to user interface controls in the form of volume buttons only, but other input devices can also be used in this invention. For example, in the case of media players or mobile telephone having a music player functionality, such user interface controls can be in the form of buttons for selecting a “next music track”, a “previous music track” or similar controls.

Generally, the invention is useful for all types of electronic devices which are associated with or connected to headsets and having controls for inputting commands or making selections, or for outputting information, related to the operation of the device. Consequently, the term “user interface input or output function” includes both input controls (such as volume or music track selection buttons) and output controls (such as display icons or various types of indicators or similar).

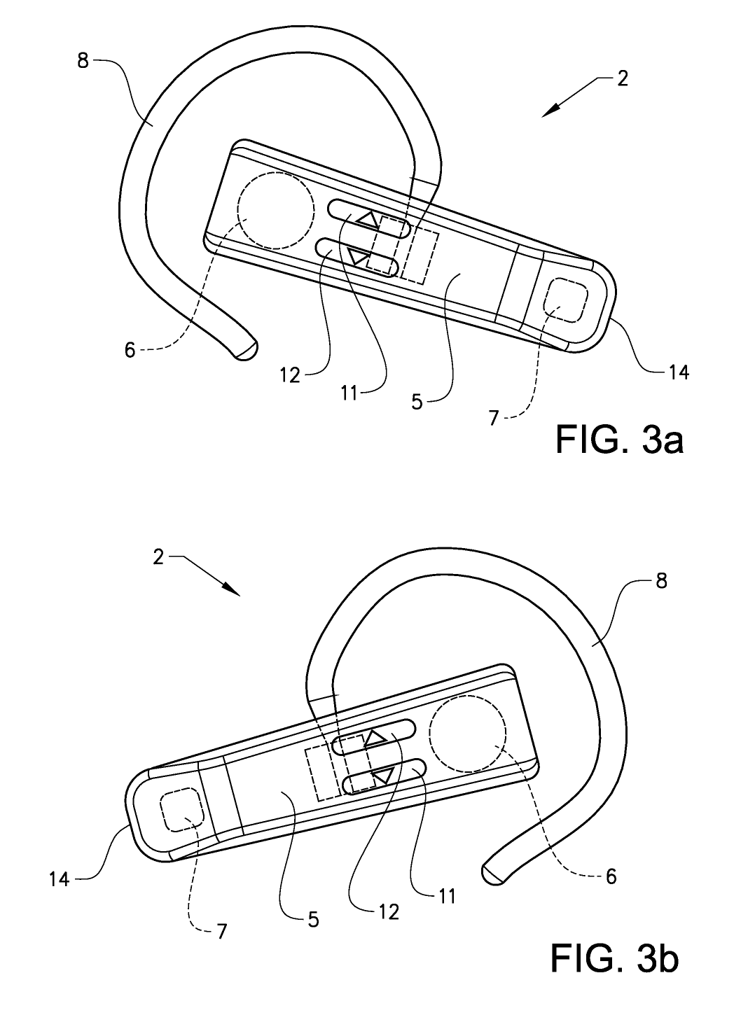

FIG. 3a and FIG. 3b show the headset 2 in two different operational positions, or configurations. More precisely, FIG. 2a shows the headset 2 in a position in which it is intended to be worn on a person's right ear, and FIG. 2b shows the headset 2 in a position in which it is intended to be worn on a person's left ear.

With reference to the drawings in FIGS. 2a, 2b and FIGS. 3a, 3b, it should be noted that the housing 5 is intended to be turned approximately 180 degrees in order to assume the position shown in FIG. 3b, i.e. when the headset 2 is worn on a person's left ear (as compared to the position shown in FIG. 3a wherein the headset 2 is to be worn on the person's right ear). It is obvious that the housing 5 can be designed with many shapes and forms, not just the one shown in the drawings. The general shape of the housing 5 is suitably elongated, in order to position the earphone 6 close to a person's ear and in order to position the microphone 7 close to a person's mouth when the headset 2 is used.

Depending on whether the headset 2 is to be used on a person's right or left ear, the ear loop device 8 can be released from its corresponding fastening component 9 (cf. FIG. 2a), turned around and then mounted again in a reversed fashion. Also, as mentioned above, in order to change the operation from a right ear (FIG. 3a) to a left ear (FIG. 3b), the housing 5 must be turned 180 degrees about a generally horizontal axis extending through the housing 5. In this manner, the headset 2 will assume the configuration shown in FIG. 3b, i.e. so as to prepare it for being worn on a person's left ear.

Furthermore, as is also apparent from FIG. 3b, when the housing 5 is arranged for use on the left ear, the buttons 11, 12 will be arranged in reversed order as compared with the situation in which the housing 5 is used on the right ear. In other words, the housing 5 will be “upside-down” in the configuration shown in FIG. 3b as compared with the configuration shown in FIG. 3a. As mentioned initially, the fact that the user interface controls, i.e. the buttons 11, 12, will be positioned in different vertical positions depending on whether the headset 2 is used on the left or right ear, can be perceived as annoying and confusing for the user.

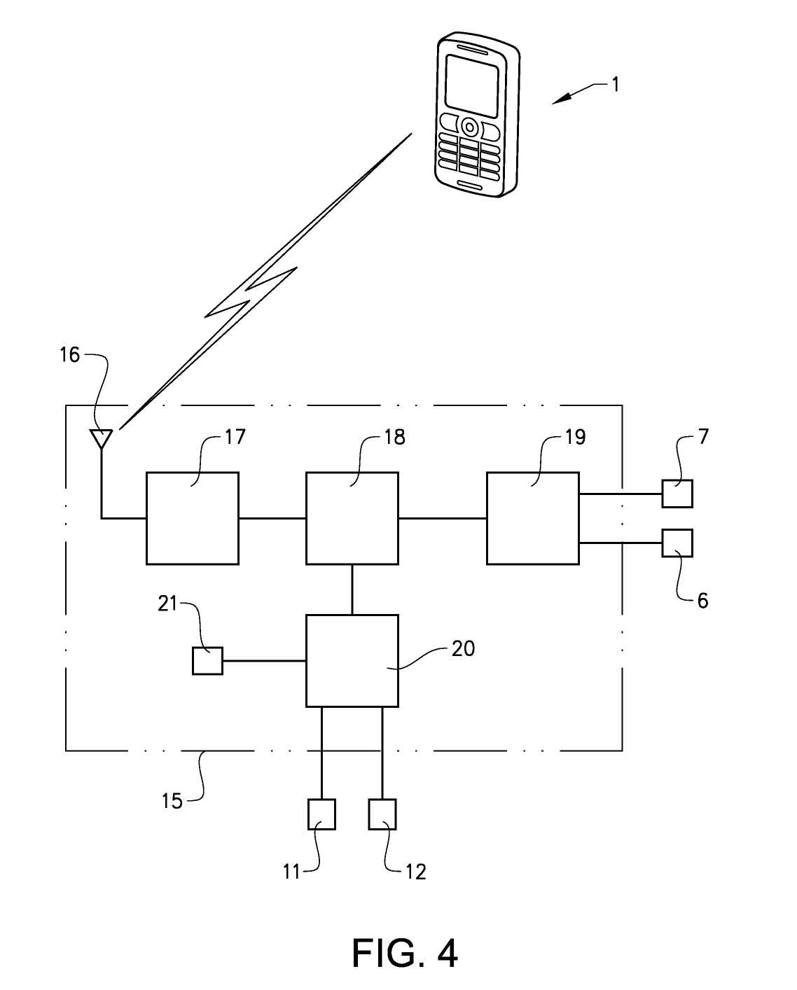

In the light of the above, it is an important principle of the invention that the headset 2 is provided with an accelerometer for detecting the orientation in at least one dimension of the housing 5. Suitably, the accelerometer is arranged so as to detect at least the vertical orientation, preferably also the horizontal orientation, of said housing 5. This important principle of the invention will now be described with reference to FIG. 4, which shows a block diagram of a headset control unit 15 which is preferably mounted as an integrated unit inside the housing 5 of the headset 2.

As shown in FIG. 4, the control unit 15 comprises an antenna 16 which is arranged for communicating with the mobile telephone 1, suitably via the Bluetooth wireless protocol as mentioned above. The antenna 16 is connected to a microprocessor 17 arranged for controlling the transmission of signals between the headset 2 and the mobile telephone 1. Furthermore, the microprocessor 18 is connected to an audio interface 19, arranged for receiving audio signals from the microphone 7 and for feeding audio signals to the earphone 6. The microprocessor 18 is also connected to I/O (input/output) unit 20, to which the above-mentioned two buttons 11, 12 are connected. Furthermore, the above-mentioned accelerometer 21 is connected to the I/O unit 20. The principles of operation of the various components of the control unit 15 are previously known as such, and for this reason they are not described in greater detail here.

The operation of the invention is based on the principle that the accelerometer 21 is used for providing input signals indicating the vertical orientation, and preferably also the horizontal operation, of the housing 5. For example, when the housing is tilted or turned so as to be switched from the configuration of FIG. 3a to the configuration of FIG. 3b, the signal from the accelerometer 21 will be used by the microprocessor 18 to adapt the function of the two buttons 11, 12 in a suitable manner. This will now be described in detail with reference to FIGS. 3a and 3b. It can be noted that the two buttons 11, 12 will be in different positions as regarded from the user's perspective depending on whether the headset 2 is used on the left or right ear. Since this is a drawback as regards the user-friendliness of the headset 2, the control unit 15 is arranged so that the configuration and function of the two buttons 11, 12 is adapted to the actual orientation of the housing 5. Preferably, the first button 11 can be used as an “increase the volume” button when the headset 2 is configured as shown in FIG. 2a, whereas the second button 12 can be used as an “increase the volume” button when the headset 2 is configured as shown in FIG. 2b. In a corresponding manner, the second button 12 can be used as a “decrease the volume” button when the headset 2 is configured as shown in FIG. 2a, whereas the first button 11 can be used as a “decrease the volume” button when the headset 2 is configured as shown in FIG. 2b.

The accelerometer 21 can be of conventional type and being, for example, of capacitive, piezoelectric or piezoresistive type. An accelerometer is generally arranged to sense and convert an external acceleration force acting on the housing 5 and being detected from a motion, for example a tilting motion such as the motion of the housing 5 when it is switched from a user's left ear to the right ear, or gravity into an electrical signal.

The invention is not limited to the embodiment described above, but may be modified without departing from the scope of the claims below. For example, the invention can suitably be used in portable, handheld terminals such as mobile telephones, but is not limited to this type of use only but can be used in media players, computers, smartphones, game units, DVD players, pagers and similar devices. In fact, the invention can be used in generally any headset being associated with one or more user interface input or output functions.

The invention can be applied in headsets being arranged for wireless or wired communication with a further unit (such as the mobile telephone described above).

The invention is furthermore not limited to user interface controls in the form of volume buttons. Such interface controls can generally be in the form of any input devices for manually inputting commands or making selections related to the operation of the device. Volume controls are just one example and other examples include display menus and icons, keyboard commands, dials and other control devices. In the case of electronic game devices, such user interface controls can be in the form of a joystick or other game control devices such as buttons or levers.

According to an alternative embodiment of the invention, it can be implemented in a headset of a type which only comprises an earphone, i.e. which is not provided with a microphone. Such a headset may be used together with a game unit, a media player or an FM radio, for example, where there normally is no need for inputting audio signals via a microphone in the headset.

Also, the invention is not limited to the case where the user interface input or output function is arranged on the headset itself. In other words, the user interface input or output function may be arranged on the headset, or on an associated device with which the headset communicates, or both.

The invention can in principle be implemented in a headset of the type which is a complete, self-contained unit with all functions integrated in the headset itself. Such a device could be for example a media player or an FM radio having all its functions within the headset itself, i.e. a device which is not being arranged to communicate with any further unit such as the embodiment above in which the headset communicates with a mobile telephone.

With reference to the embodiment shown in FIG. 2b, wherein two buttons 11, 12 are positioned on the outer side 13 of the headset 2, it should be noted that such buttons can be positioned for example on the top side and bottom side, respectively, of the headset also. Consequently, many alternative embodiments are possible within the scope of the invention.

In order to position the headset in the vicinity of a user's ear, it comprises a fastening element which suitably comprises a so-called ear loop device, i.e. a generally annular element used in order to mount the headset on either the left or right ear of the user. According to an alternative, the fastening element may be of a kind which is adapted for mounting on a pair of eyeglasses, and wherein the actual housing is still positioned so that the earphone is close to the user's ear.

1. A headset comprising a housing with an earphone and at least one user interface input or output function, said headset also comprising a fastening element arranged for positioning the headset close to a person's ear during use, wherein said headset furthermore comprises an accelerometer arranged for detecting the orientation in at least one dimension of said housing, said accelerometer being associated with a headset control unit which is arranged for configuring a function of said user interface input or output function depending on said orientation of the housing.

2. A headset according to claim 1, wherein said user interface input or output function comprises a set of buttons or similar controls for controlling the volume of said earphone.

3. A headset according to claim 1, wherein the housing also comprises a microphone.

4. A headset according to claim 3, wherein the housing has a generally elongated shape so as to allow positioning of the earphone close to a user's ear and to allow positioning of the microphone close to a user's mouth.

5. A headset according to claim 1, wherein the accelerometer is arranged for detecting the orientation in at least two dimensions of said housing.

6. A headset according to claim 1, wherein the headset is associated with a communication device.

7. A headset according to claim 6, wherein the communication device is constituted by a mobile telephone.

8. A headset according to claim 6, wherein the headset is arranged for communicating with said communication device via a wireless connection.

9. A headset according to claim 8, wherein the wireless connection is arranged in accordance with the Bluetooth wireless protocol.

10. A headset according to claim 6, wherein the headset is arranged for communicating with the communication device via a wired connection.

11. A headset according to claim 1, wherein said fastening element is constituted by an essentially annular ear loop device (8) for mounting said headset on a user s left or right ear.

12. A headset according to claim 2, wherein the housing also comprises a microphone.

13. A headset according to claim 7, wherein the headset is arranged for communicating with said communication device via a wireless connection.

14. A headset according to claim 7, wherein the headset is arranged for communicating with the communication device via a wired connection.
